(19) United States
(12) Patent Application Publication
(10) Pub. No.: US 2007/0299566 A1
(43) Pub. Date: Dec. 27, 2007

(54) Method for Controlling an Electronic Parking Brake

(76) Inventors: Stefan Goss, Brunn (DE); Alexander Kalbeck, Burglenfenfeld (DE); Armin Sauer, Arnstein (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/571,632

(22) PCT Filed: Apr. 22, 2005
(86) PCT No.: PCT/EP05/51793

§ 371 Date: Jan. 4, 2007

(30) Foreign Application Priority Data
Jul. 7, 2004 (DE) 102004032898.6

(51) Int. Cl. G06F 19/00; B60T 13/74

(52) U.S. Cl. 701/1; 188/158

(57) ABSTRACT

In a method for controlling an electronic parking brake system and an electronic parking brake system, a travel-optimized method is used to achieve the released state of the parking brake system. When the parking brake is applied, travel-force values are detected and a plausibility check is run, the values being used to arrive at a first optimized position when the brake is released. If the residual force applied to the brake exceeds a threshold value, the parking brake is released even more until the value remains just under the threshold value or until a maximum defined release travel is achieved.

### CROSS-REFERENCE TO RELATED APPLICATIONS

This application is a U.S. national stage application of International Application No. PCT/EP2005/051793 filed Apr. 22, 2005, which designates the United States of America, and claims priority to German application number DE 10 2004 032 898.6 filed Jul. 7, 2004, the contents of which are hereby incorporated by reference in their entirety.

### TECHNICAL FIELD

The invention relates to a method for controlling an electronic parking brake with a force control taking place when the parking brake is applied. The invention further relates to an electronic parking brake that can be applied using force control.

### BACKGROUND

Electronic parking brakes, also known as electronic, electrical or automatic parking brakes, are increasingly replacing purely mechanical handbrakes in motor vehicles. The use of electronic parking brake systems does away with the operating lever, usually rather large, in the passenger compartment, thus providing a substantially increased design freedom for the passenger compartment. Furthermore, a system of this kind offers greater operating comfort because the operator does not have to use great force in order to apply or release the brakes and also various functions such as pulling away on a hill or releasing the brake when first starting from parking is performed electronically and thus also automatically. These advantageous features of electronic parking brake systems must, however, provide safety that is equal to or better than a purely mechanical handbrake.

When controlling or regulating (in this document the term control means both open-loop and closed-loop control) a parking brake of this kind, for example by means of an electric motor-gearbox unit, there is usually a discrepancy between the position of the gear and the force applied at the brakes. This is due to the physical properties of the brake system and the force transmission device and usually manifests itself in hysteresis effects. In this context, the term force transmission device includes both the actuator and all parts that transmit the forces to the brakes, and also components on which the force of the actuator acts. Because such a clear assignment between the position of the gear and the braking force can be realized only with difficulty, control does not usually take place through the gear or motor position alone. Alternatively, control of the electronic parking brake system can be by means of a force measurement at the force transmission device. An exclusive control or regulation control by means of the force applied at the force transmission device of the brake is, however, ruled out for safety-related reasons because the force in the force transmission device and also the aforementioned hysteresis effect have to be taken into account. For these reasons, a combined force-travel control system is usually used for electronic parking brake systems.

According to prior art, the application of a parking brake proceeds as follows. Beginning from a starting position the parking brake is applied. The force present at the force transmission device must reach, or exceed, a preset value within a predetermined travel. Fixed permissible minimum and maximum limits are set for the distance to be traveled. Because in addition to the aforementioned hysteresis effect, the parking brake usually also shows signs of ageing or fatigue and therefore the force-travel relationship changes, not only in the course of the application-release operation but also over the service life of the parking brake, the chosen range between the minimum and maximum limits must be relatively large. Otherwise, an undesirable frequent readjustment of the parking brake would be necessary, which would be detrimental to a maintenance-free functionality of the parking brake over the complete service life of the vehicle. The consequence of this is that changes in the travel-force characteristic of the parking brake that compared with gradual ageing occur abruptly or only temporarily but still lie within the relatively wide permissible range, are not detected. Just such sudden relatively fast changes can, however, have safety implications.

### SUMMARY

The object of the invention is to eliminate the disadvantages of prior art and especially to provide a method for the control of an electronic parking brake, and/or an electronic parking brake, that takes better account of the safety-relevant changes in the parking brake.

In a method for controlling an electronic parking brake with a force control taking place during the application of the parking brake, the following steps can be performed:
performing a force measurement during the application of the parking brake and, depending on the measured force, at least one first position and therefore at least one force-position assignment is determined, and
comparing the first position with a predetermined position for the purpose of a plausibility check of the force-position assignment.

### BRIEF DESCRIPTION OF THE DRAWINGS

The invention is now explained in the following with reference to the appended drawings using preferred exemplary embodiments, in which;

FIG. 1 shows a flow diagram for explaining a first application operation of a parking brake according to the invention.

FIG. 2 shows a flow diagram for explaining a release operation of a parking brake.

FIGS. 3a-3b shows flow diagrams for explaining a first calibration operation of a parking brake according to the invention.

FIG. 4 shows a flow diagram for explaining a second application operation of a parking brake according to the invention

FIG. 5 shows a flow diagram for explaining a second calibration operation of a parking brake according to the invention.

FIGS. 6a-6c shows functional block diagrams for explaining a first device in various states according to the invention

FIG. 7 shows a functional block diagram for explaining a second device according to the invention

FIG. 8 shows a force-position diagram

### DETAILED DESCRIPTION

The invention is based on the generic method in that when the parking brake is applied a force measurement takes place and, depending on the measured force, at least one first position and thus at least one force-position assignment, is determined, and that the first position is compared with a predetermined position to check the plausibility of the force-position assignment. The position, determined when applying the parking brake, assigned to a specific force, enables this position to be compared with a predetermined position assigned to the force. In this way, the plausibility of the force-position value pair determined during the application of the parking brake can be checked and a greater reliability of the application process and/or operation of the parking brake generally achieved. The predetermined position can, for example, be the result of a calculation, be an empirical value or be measured under different circumstances or at a different time point. The plausibility of the actual force-position assignment at the first position can be checked for any obvious deviation from the value pair checked at the predetermined position. This can also be taken into account during a safety appraisal of the values. In this way, temporary faults that, with a parking brake according to prior art, lie within the relatively broad tolerance limits, can be detected and reported or allowed for in some form. Overall, this method leads to an earlier detection and more precise identification of faults, thus increasing the operating safety and reliability over the complete service life of the parking brake. The position and the force values can be determined directly by position and force measurement, and alternatively or additionally, the speed of the actuator and/or the gradient of the force acting against the force transmission device can also be taken into account.

According to an embodiment, it can be provided that at the first position a force is present that corresponds to an applied state of the parking brake. Therefore when the parking brake is applied a measurement of the force takes place to determine whether a force corresponding to an applied state of the parking brake is present at the force transmission device. The position thus determined is compared with a position that enables the plausibility of the state of the parking brake as “applied” to be checked. After a safety assessment based on the result of the comparison, the status of the system can be set to “applied” or “not applied” depending on the safety criteria used.

According to a further embodiment, it can be provided that part of the force-position curve is recorded by determining several force-position assignments during the application of the parking brake. If several force-position assignments are determined when applying the parking brake, the momentary characteristic of the parking brake during application can be recorded in the form of a force-position curve. This can represent a certain relevant section of the application of the parking brake. Also alternatively or additionally, several sections or the complete force-position curve when applying the parking brake can be recorded. This enables a substantial refinement of the plausibility checking possibilities of the determined force-position assignments, so that the comparison can be made not just on the basis of a single force-position value pair but also on a substantial part of the force-position curve. Furthermore, the safety check is improved because a greater number of values from a widespread range can be included. This not only enables any measuring errors that may be present to be reduced but also measured values from the environment of the first position can make an evaluation based on speed or on a force gradient possible or easier.

According to an embodiment, the predetermined position for an applied state of the parking brake is a typical position. The comparison of the first position or of a part or of the complete force-position curve with a predetermined position typical of the applied state of the parking brake is a particularly advantageous plausibility check of the force-position assignment representing the momentary state of the parking brake. The typical position value can be an ex works predetermined specified and fixed value or it can also be calculated from system data and determined in some other way, or be produced by a combination of these two possibilities. This typical value enables a plausibility check using data determined or calculated in some other way and therefore also represents an important safety check.

According to an embodiment, it can be provided that the predetermined position was determined in the course of determining the first position at an earlier application operation. This type of plausibility check supplements or replaces the comparison of the force-position assignments determined at the first position with typical values. The comparison with a force-position assignment determined at an earlier application operation in particular enables slight but nevertheless safety-relevant deviations that occur at certain time points to be determined, and reported as faults as necessary. Special ageing processes or evidence of fatigue can thus be detected and allowed for by using a time characteristic covering several application operations.

According to an embodiment, the first position is compared with a predetermined range. In this way, in conjunction with the preceding features, this enables the momentarily recorded force-position curve when applying the parking brake to be compared with curves that were specified ex works and given as typical curves or determined during preceding application operations. This enables an extensive and comprehensive plausibility check of the determined measured values while at the same time offering a comprehensive safety-related analysis of the momentary and previous functionality of the parking brake. The functionality and safety of the parking brake over the complete service life of the vehicle can thus be tracked and ensured on the basis of currently determined, previously stored and/or permanently entered values.

The invention is based on the generic device in that when the parking brake is applied, a force can be determined and at least one first position and thus at least one force-position assignment can be determined relative to the measured force, and that the first position is compared with a predetermined position as a plausibility check of the force-position assignment. In this way, the advantages and particular features of the method according to the invention can also be realized in the context of a device. This also applies to the following particularly preferred form of embodiment of the device according to the invention.

According to an embodiment, a force is present at the first position that corresponds to an applied state of the parking brake.

According to a further embodiment, at least part of a force-position curve can be recorded by determining several force-position assignments during the application of the parking brake.

According to a further embodiment, the predetermined position is a position typical of an applied state of the parking brake.

Furthermore, an embodiment can advantageously be developed in that the predetermined position can be determined when ascertaining the first position during an earlier application operation.

According to a further embodiment, the first position can be compared with positions from a predetermined range.

The invention furthermore refers to an operating brake with a device in accordance with the invention as well as a vehicle with an electronic parking brake according to the invention.

The invention is based on the knowledge that by determining the force-position assignments during the application operation of an electronic parking brake a plausibility check of the determined measured values can take place. In particular, by recording several force-position assignments or comparing same with specified typical value pairs, or value pairs determined during preceding application operations, a comprehensive and reliable plausibility check as well as a substantially improved safety check of the system can be achieved.

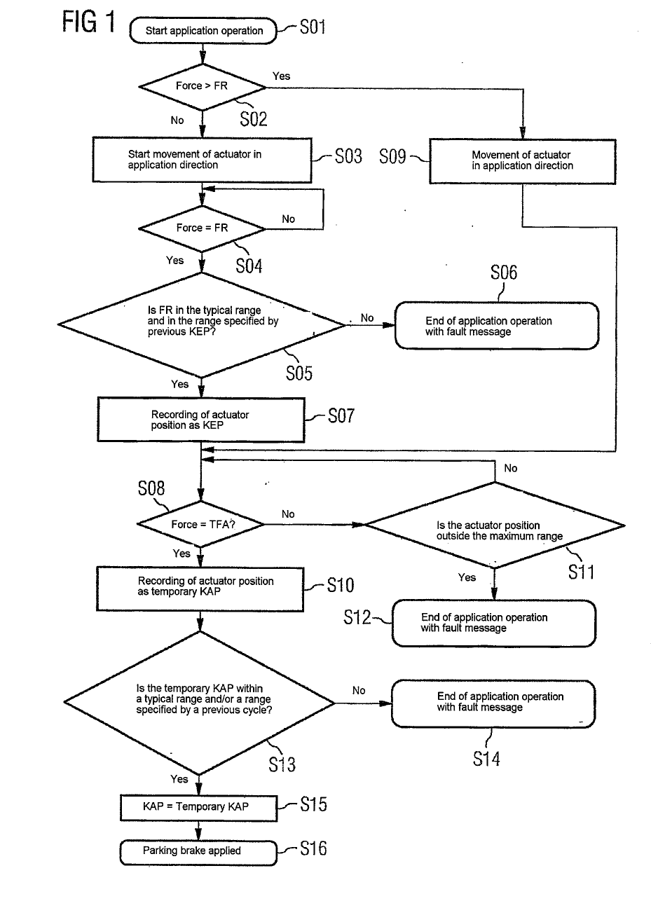

FIG. 1 is a flow diagram for explaining a first application operation of a parking brake according to the invention. The process begins with step SO1, at which the electronic control or regulation of the parking brake system begins to implement the instruction “Apply parking brake”. For this purpose, as shown in decision SO2, a check of the momentary force present at the force transmission device takes place. If this is less than what is called a force reference FR, the actuator is moved in the application direction (step 303). Immediately the force present at the force transmission device reaches or exceeds the value FR (decision SO4), a check is carried out to determine whether the momentary force value is within a typical range and within a range specified by the force application point (KEP) determined by the previous cycle (decision S05). If the result of this plausibility check is negative, the application operation can end here with a fault message (step SO6) and/or a fault can be reported. If the result is positive of the test, the process moves on to step S07. Here, the momentary actuating position is saved as a new force application point (KEP). After this step, the method continues with decision S08 in which again a check of the momentary applied force is made. This check also takes place if the method when checking the force present at the force transmission device in decision S02 has determined a value that is greater than FR and has also, as in step S03, initiated with step S09 the movement of the actuator in the application direction. If in decision S08 the force present exceeds or reaches a second limit value, the target forces apply TFA, then in step S10 the momentary actuator position is recorded as a temporary switch-off point. The check is carried out in another way by checking the momentary actuator position against a maximum value (decision S11). If this is not exceeded, the process continues with decision S08, otherwise the process is ended with a fault message at this point in step S12. With the recording of the force shut-off point a check is carried out in decision S13 to determine whether the value KAP lies within a typical range and/or a range specified by a previous cycle. If the result is negative, the process ends at this point with a fault message in step S14. In other cases, the temporary switch-off point is stored as the new switch-off point KAP to be used (step S15). The parking brake system is now in the applied or fixed state (section S16).

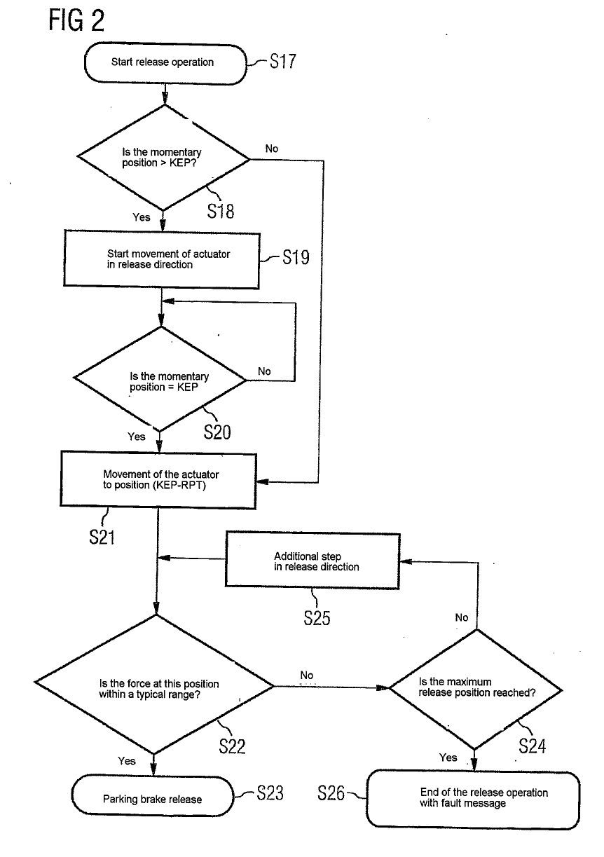

FIG. 2 shows a flow diagram to explain a release operation of a parking brake. If, as shown in FIG. 2, the control or regulating system provides the instruction “Release parking brake”, shown in step 17, representing a driver's wish or triggered by an automatic function, a control or check of the position of the actuator takes place. As shown in decision S18, the position is checked to see if it reaches the KEP. If this is not reached, the actuator, in step S19, begins to move in a direction opposite to the application direction, i.e. the release direction. This movement persists until in decision S20 when checking the momentary actuator position it is determined that the KEP has been reached. The movement of the actuator then continues again in the release direction in step S21. This time no absolute position is reached, instead the actuator is moved by the release position travel PRT relative to the KEP. At this point, movement begins again if achievement of the KEP was already determined in step 18. After the RPT has been traveled, the force present at the force transmission device is again determined, as shown in decision S22. If this is below a limit value known as the target force release TFR and is within a typical range, the process is ended with step S23. Otherwise, a check is carried out to determine whether the actuator has reached a maximum value position (decision S24). If this is not the case, the actuator is moved a further additional step in the release direction (step S25) and the applied force is again checked in step S22. Otherwise, the process ends at this point in step S26 with a fault message. The process iteratively repeats steps S22, S24 and S25, i.e. it moves the actuator in the release direction and compares the force present there with the limit value TFR, until the residual force drops below the limit value or a maximum travel distance has been covered. This completes the process.

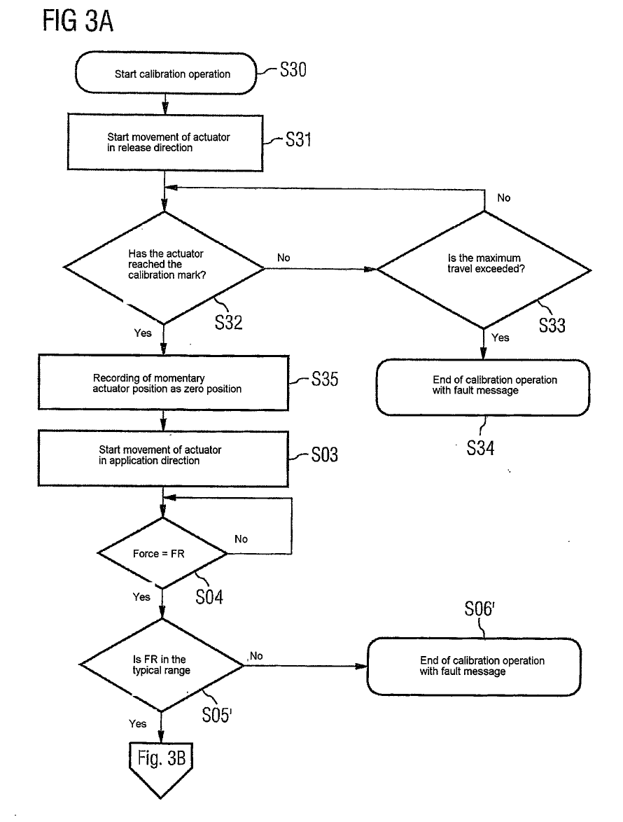

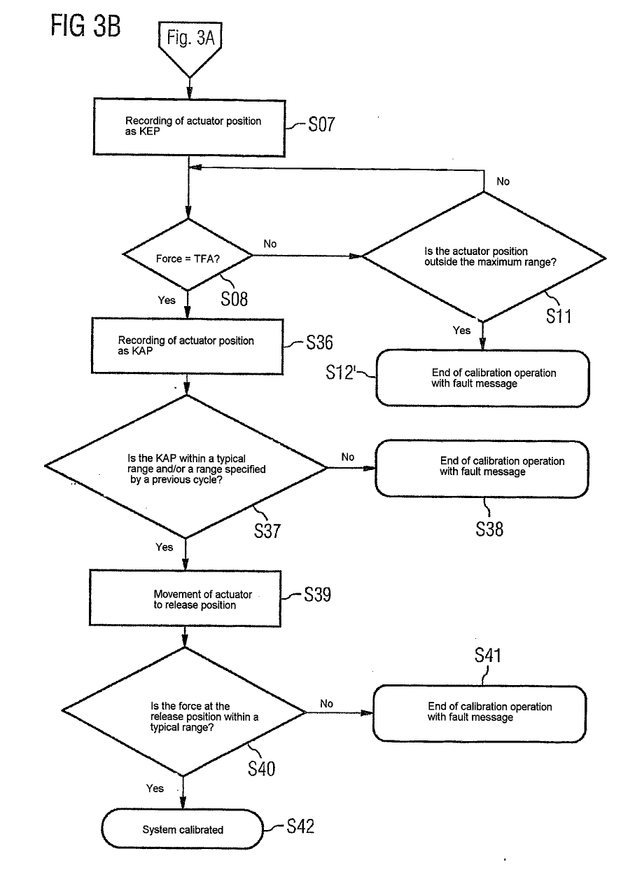

FIGS. 3a-3b show flow diagrams explaining a first calibration operation of a parking brake in accordance with the invention. It can be provided that the method as claimed in the invention performs a calibration run. To do this, the process in FIG. 3a begins with step S30, with which the calibration run is started. The actuator is first moved in the release direction (step S31). At the same time, it is determined in decision S32 whether the actuator has reached a zero position or a calibration mark. If this is not the case, the process is ended in step S34 with a fault message if a maximum travel distance has been exceeded (decision S33). Otherwise, the process continues with decision S32. When the calibration mark or zero position has been reached, then, in step S35, the momentary position of the actuator is stored as a zero position. This is followed by process steps corresponding to steps S03 to S08, S11 and S12 previously described with FIG. 1 and therefore are not further explained. Furthermore, steps S05, S06 and S12 are to be appropriately adjusted and are therefore designated as S05′, S06′ and S12′ after, as shown in FIG. 3b, the application of TFA to the force transmission device was detected in decision S08, the momentary position is saved, in step S36, as a force switch-off point (KAP). Furthermore, in decision S37 a check is made to determine whether the KAP value lies within a typical range and/or a range specified by a previous cycle. If this is not the case, the process is ended in step S38 with a fault message. The process then continues with step S39 and releases the actuator up to the calculated release position. There, the force present on the force transmission device is checked (decision S40). If this is not within a typical range, the process is ended in step S41 with a fault message otherwise the system is in the calibrated state with S42.

This enables an absolute positioning to be performed for points KEP and KAP that, amongst other things, can be used for checking the plausibility of the values determined in the further application operations.

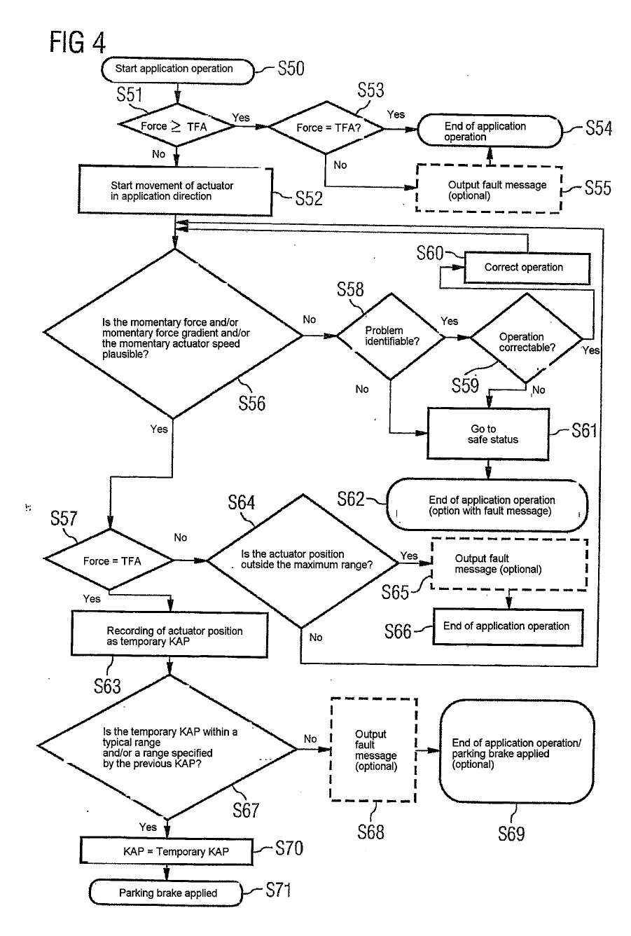

FIG. 4 shows a flow diagram explaining a second application operation of a parking brake according to the invention. The process starts with step S50 at which the electronic control system, or regulating system, of the parking brake system begins to implement the instruction “Apply parking brake”. For this purpose, a check, as shown in decision S51, of the momentary force present at the force transmission device takes place. If this is less than the target force apply TFA, the actuator is moved in the application direction (S52). If however, the momentary force present is greater or equal to the target force apply, a check is carried out in decision S53 to determine whether the force momentarily present is equal to the target force apply TFA. If it is, the process ends with step S54. Otherwise, a fault message is generated in step S55 and the process also ends with step S54. The generation of a fault message in step S55 can optionally be omitted.

After step S52, several variables can be monitored in step S56. The force present at the momentary position, the force gradient and/or momentary speed of the actuator at the momentary position can be determined individually, simultaneously or in any combination. Depending on the plausibility of the determined measured values, the application operation of the actuator is continued with decision S57, or if there is no plausibility an attempt is made in decision S58 to identify the problem causing the absence of plausibility. If the problem is identified, a check (decision S59) is carried out to determine whether the momentary occurrence causing the problem can be corrected. If this is the case, the momentary occurrence is changed in step S60 in order to remove the problem and the process continues with step S56.

If on the other hand it is determined in decision S59 that the occurrence cannot be corrected or if in decision S58 it is determined that the problem was not detected, the parking brake is brought to a safe state (step S61) and the application operation is ended at this point with step S62 (with a fault message as an option). The plausibility check beginning with decision S56 can also be optionally omitted for the pure functionality of the application operation. If in decision S57 it is determined that the momentary force corresponds to the target force apply TFA, the momentary position is recorded as a temporary force switch-off point KAP (step S63).

If the target force apply is still not reached, a check is carried out in decision S64 to determine whether the momentary position is outside a maximum permissible range. If this is not the case, the process continues with decision S56. Otherwise, a fault message is generated in step S65 as an option and the process ends with step S66. In decision S67, that follows on step S63, a check is carried out to determine whether the temporary switch shut-off point is within a typical specified range and within a range specified by the preceding switch shut-off points. If this is not the case, a fault message can be generated in step S68 as an option and the process ends with step S69.

An option at this point is to end the application operation and also consider the parking brake as “applied”. If the check of the temporary force switch-off point in decision S67 is positive, the temporary force switch-off point is specified in step S70 as the new force switch-off point KAP to be used. The parking brake system is now in the fixed or applied state (step S71).

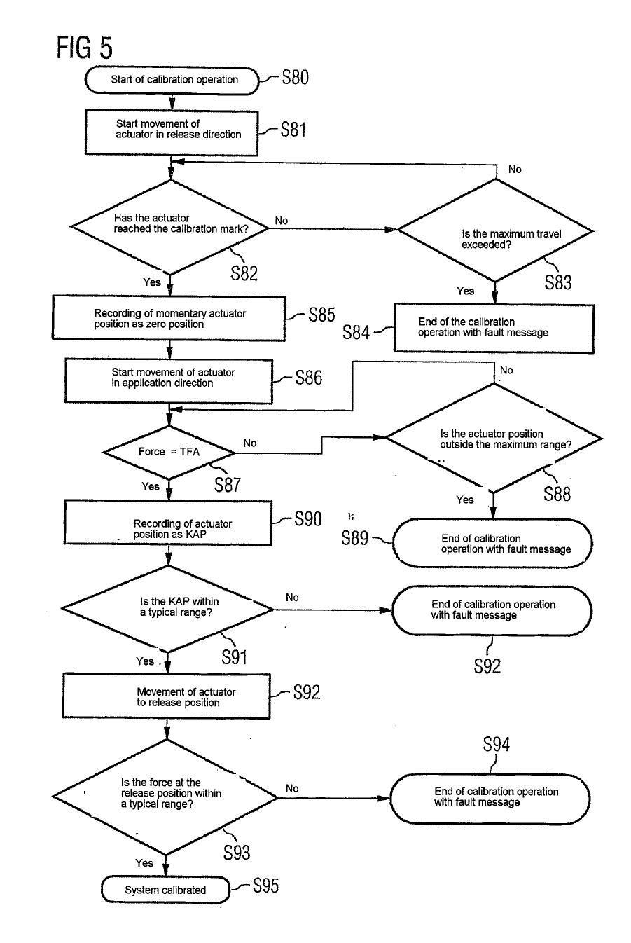

FIG. 5 is a flow diagram explaining a second calibration operation of a parking brake according to the invention. The calibration operation begins with step S80. The actuator is then moved in the release direction (step S81). At the same time, it is determined in the decision S82 whether the actuator has reached a zero position or a calibration mark. If this is not the case and a maximum travel distance has been exceeded, (decision 83), the process is ended in step S84 with a fault message. Otherwise, the process continues with decision S82.

If the calibration mark or the zero position has been reached, the momentary position of the actuator is stored as the zero position in step S85. An application operation of the actuator then begins in step S86. In decision S87 a check is made to determine whether the target force apply TFA on the actuator has been reached. If this is not the case and it has been determined in the decision S88 that a maximum range for the position of the actuator is not exceeded, the application operation is continued. If on the other hand a maximum range for the actuator position has been exceeded, the calibration operation ends in step S89 with a fault message.

If in decision S87 it is determined that the target force apply on the actuator has been reached, the momentary position is established as the force shut-off point KAP (section S90). Then, in decision S91 a check is carried out to determine whether this force shut-off point KAP lies within a typical range. If the result of the test is negative, the calibration operation ends at this point with a fault message in step S92. If the force shut-off point KAP lies within a typical range a release operation can be activated in step S92.

For this, the brake is opened up to a release point RP. In decision S93 a check is also made to determine whether the force present at the actuator at the release point lies within a typical range. If this is not the case, the calibration operation ends with a fault message in step S94. There is also the option to omit steps S92 to S94. If the check of the force on the actuator at the release point (decision S93) or at the force switch-off point (decision S91) is positive, the system is in the calibrated state with step S95.

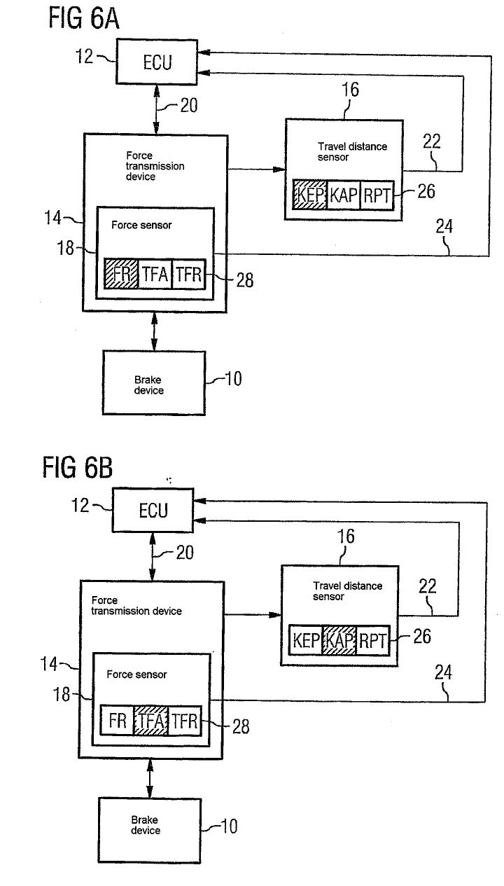

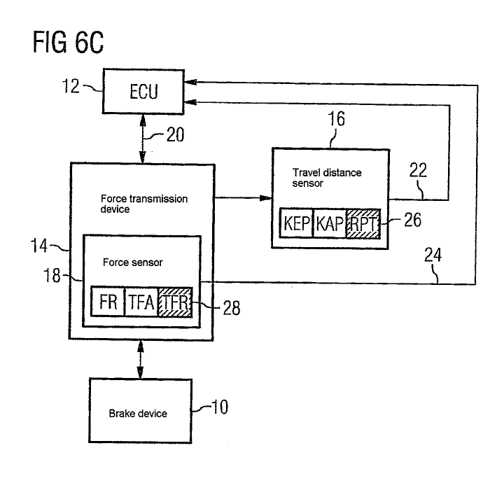

FIGS. 6a-6b show functional block diagrams for explaining a first device in various states according to the invention. In addition to the electronic, mechanical and any hydraulic components, referred to here using the term brake device 10, known according to prior art, the illustrated embodiment has an electronic control unit (ECU) 12, a force transmission device 14, a travel distance sensor 16 and a force sensor 18. In this connection, as also already in the descriptive part, the term force transmission device should include both an actuator, all parts that transmit forces to the brakes and also components on which the force of the actuator acts. The force sensor 18 can be fitted at any suitable point either within the force transmission device 14 or outside it, including in the brake device 10.

The electronic control unit 12 is connected by a signal line 20 to the force transmission device 14 that has an active mechanical connection to the brake device 10. The travel distance sensor 16 receives a position signal from the force transmission device 14 and applies this as position information 22 to the electronic control unit 12. Similarly, the force sensor 18 generates a measuring signal 24 corresponding to the momentary force present at the force transmission device or the brake device and supplies this also to the electronic control unit 12. Both the travel distance sensor 16 and the force sensor 18 are provided with a symbol display 26 or 28 that depicts various selected signals. With the travel distance sensor 20 signals KAP, KEP and RPT are highlighted and the indicator 28 of the force sensor 18 highlights signals FR, TFA and TFR.

The embodiment shown in FIGS. 2a, 2b and 2c is identical in its components and with respect to its reference characters, and differs only with regard to the signals 20 and 22 supplied by sensors 16 and 18 that correspond to different actuator positions and therefore to different states of the parking brake.

In FIG. 6a, the electronic control unit 12 has given an instruction to the actuator of the force transmission device 14 to move in the application direction, i.e. the parking brake is to be applied. At the moment shown, the reference force FR is present at the force transmission device 14. Accordingly, the travel sensor 16 applies signal 22 representing the force application point KEP to the electronic control unit 12 that records this travel distance value provided the plausibility check has been successfully performed.

In FIG. 6b, the position for the applied state of the brake is reached. Furthermore, the target force apply (TFA), the level of which is transmitted by the force sensor 18 as signal 24 to the electronic control unit 12, is present at the force transmission device 14. This level of force is now correlated with the momentary actuator position with the aid of the travel distance sensor 16. To do this, the electronic control unit 12 stores the travel distance signal 22 as a temporary force switch-off point, compares it as part of the plausibility check with a typical and/or value range specified by a previous cycle and, if the check is successful, stores it as a new force switch-off point (KAP) to be used.

FIG. 6c shows a state of the electronic parking brake system that is assumed when the parking brake is being released. During this, the actuator of the force transmission device 14 is first moved again by a signal 20 from the electronic control unit 12 until the force application point (KEP) is reached, corresponding to the state shown in FIG. 2a. After the KEP has been reached, the actuator of the force transmission device 14 is moved starting from there over the release position travel RPT distance further in the release direction. The travel distance sensor 16 accordingly indicates by means of signal 22 that the RPT has been reached. The electronic control unit 12 receives this signal 22 and compares the force signal 24 from the force sensor 18 with a limit value, the target force release (TFR).

Because at that moment the target force release TFR is actually present at the actuator of the force transmission device 14, the state shown in FIG. 2c represents the released state of the parking brake.

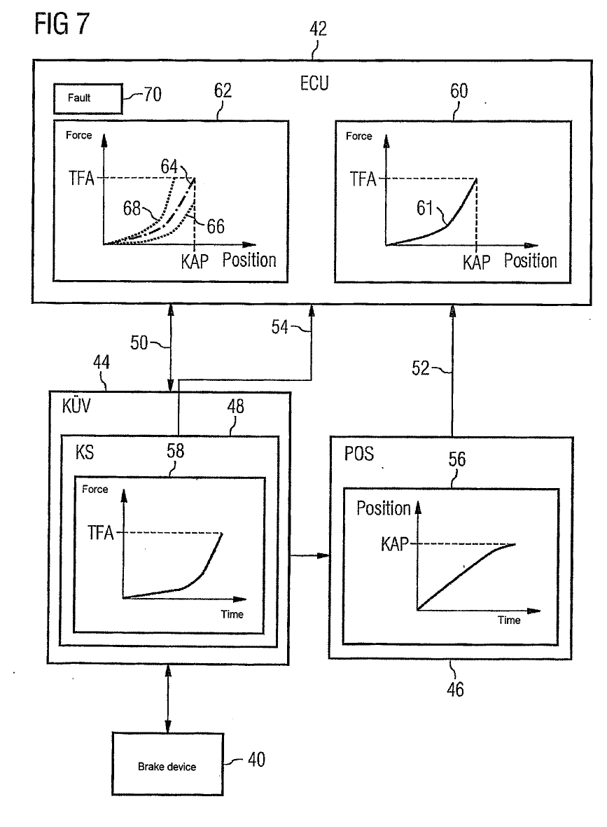

FIG. 7 shows a functional block diagram for explaining a second device according to the invention. The illustrated embodiment, as for the embodiment illustrated in FIGS. 6a-6c, also has, in addition to the electronic, mechanical and perhaps hydraulic components known from prior art and collectively referred to here using the term brake device (BV) 40, an electronic control unit (ECU) 42, a force transmission device (KUV) 44 as well as a position sensor (POS) 46 and a force sensor (HS) 48.

In this regard, as already in the descriptive part and previously described embodiment, the term force transmission device includes not only an actuator and all parts that transmit forces to the brakes but also components on which the force of the actuator acts. The force sensor 48 can again be fitted at any suitable point either within this force transmission device 44 or outside it, including also in the brake device 40. The electronic control unit 42 is connected by the signal line 50 to the force transmission device 44 that has a mechanically active connection to the brake device 40.

The position sensor 46 detects a position signal supplied from the force transmission device 44 and applies this as position information 52 to the electronic control unit 42. In a similar manner, the force sensor 48 generates a measuring signal 54 corresponding to the force momentarily present at the force transmission device 44 or brake device 40 and likewise outputs this signal to the electronic control unit 42. Both the travel distance sensor 46 and the force sensor 48 are provided with symbol diagrams 56 or 58 respectively. These represent the time characteristic of measuring signals generated during an application operation.

If the application operation proceeds correctly, the recording of the force signal ends, as illustrated, when the target force apply TFA is reached. In a similar manner, the recording of the position signal ends when the force shut-off point KAP is reached. Diagrams 60 and 62 are also represented in the electronic control unit (ECU) 42. Diagram 60 represents the force-position assignment 61 determined from the signals 52 and 54. Diagram 62 shows a force-position assignment 64 determined from earlier application operations and specified typical force-position assignments 66 or 68. Furthermore, the electronic control unit 42 has a fault display 70.

The electronic control device 42 shows an application operation of the parking brake with the actuator of the force transmission device 44 moving in the application direction, i.e. the parking brake is to be applied. The time characteristic of the movement of the actuator of the force transmission device 44 is determined by the position sensor 46. The position values thus determined over time are shown in diagram 56 and the measured values are fed to the electronic control unit 42 as signal 52. At the same time, the force sensor 48 at the force transmission device 44 measures the time pattern of the force present at the actuator.

The force signal thus generated over time is shown in diagram 58 and is also fed as measuring information 54 to the electronic control unit 42. If the force present at the force transmission device 44 exceeds or reaches the target force apply TFA, the electronic control unit 42 stops the application operation. The actuator has thus reached the force switch-off point KAP. The signals 54 and 52 generated by the force sensor 48 and position sensor 46 are recorded in the electronic control unit as force-position value pairs.

This is shown in the diagram 60. The force-position curve 61 determined in this way can extend over the complete application operation or only over part of same. During the complete application operation, especially when reaching the target force apply TFA, the electronic control unit 42 performs a comparison of the measured force-position assignment 61 with data determined during preceding application operations and/or specified typical data. With the aid of the typical range specified by curves 66 and 68, the electronic control unit 42 can perform a first plausibility check of the curve 61. Furthermore, the electronic control units 42 can compare the curve 64 determined from one or more of the preceding application operations with the momentarily determined curve 61 and thus perform a further plausibility check. If a deviation that is relevant to functionality or safety occurs during either of these two plausibility checks, the electronic control unit 42 outputs a fault message 70. If on the other hand, the plausibility and safety checks are positive, the application operation has been successful and the parking brake is in the applied position.

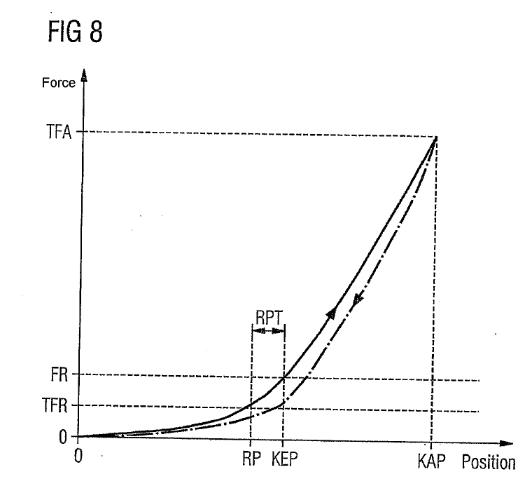

FIG. 8 shows a force-position diagram. It shows the movements of the actuator that occur with the method according to the invention and with a device according to the invention, and also an example of the force present at the actuator. A position corresponding to the momentary actuator position, with the ordinates reflecting the force at the force transmission device is plotted on the abscissa of the diagram. The release point (RP), the force application point (KEP), the force switch-off point (KAP) and the release position travel (RPT) are applied to the position values with the target force release (TFR), the reference force (FR) and the target force release (TFA) being applied to the force values. The curve shown by an arrow is an example of the assignment of the actuator position to the force momentarily present at the force transmission device when the parking brake is being applied, the curve consisting of dots and dashes with an arrow pointing in the opposite direction represents the assignment of the actuator position to the force momentarily present at the force transmission device when the parking brake is being released.

During a movement of the actuator, starting from the zero position in the direction KEP, the force-position function follows the unbroken line. If the force present at the force transmission device exceeds the value FR, the momentary actuator position is determined as KEP. During further application of the parking brake, the force present at the force transmission device reaches the value TFA, following the unbroken line further. This force value is assigned to position KAP. When the parking brake is released, the force assigned to the position now follows the line consisting of dots and dashes. In doing so, the position KEP determined during the application of the parking brake is first reached. Continuing from there, the actuator moves further in the release direction over the relative travel distance RPT. Due to the physical characteristics of the braking system, the line represented by dots and dashes normally runs below the continuous line, because of the aforementioned hysteresis effect. For this reason, the force present at the force transmission device when position KEP is reached is less than FR and may be greater than TFR, but would not immediately reach the value FR if an application of the parking brake followed directly. At the position determined by the relative travel distance RPT, a check is now carried out to determine whether the force present at the force transmission device is less than TFR. This is the case in FIG. 3 whereby the release point RP is reached and the method in accordance with the invention ends at this point. If the force present at the force transmission device still exceeds the value TFR, the actuator would move further in the release direction until the force present at the force transmission device dropped below the value TFR.

With an application operation according to the alternative embodiment, the actuator, for example, starts in the application direction from the released position RP. Force-position assignments are made at regular intervals during the application and a plausibility check of these assignments with respect to functional and safety-related aspects takes place during the application. When the target force apply TFA is reached, the application operation ends and the actuator is then in the force switch-off point KAP. The determined force values, the force gradient resulting at the momentary position and/or the speed of the actuator can be used for a plausibility check of the determined force-position assignment.

A method for controlling or regulating an electronic parking brake system and an electronic parking brake system are disclosed, with force-position assignments being made when the parking brake system reaches the applied state. A plausibility check for the functioning and/or safety of the parking brake system is carried out using these force-position values.

The features of the invention disclosed in the preceding description, in the drawings and in the claims can be essential both individually and in any combination for the implementation of the invention.

What is claimed is:

1. A method for controlling an electronic parking brake with a force control taking place during the application of the parking brake,
that the method comprising the steps of:
performing a force measurement during the application of the parking brake and, depending on the measured force, at least one first position and therefore at least one force-position assignment is determined,
comparing the first position with a predetermined position for the purpose of a plausibility check of the force-position assignment.

2. The method according to claim 1,
wherein
a force is present at the first position, said force corresponding to the applied state of the parking brake.

3. The method according to claim 1,
wherein
by determining several force-position assignments during the application of the parking brake, at least one part of a force-position curve is recorded.

4. The method according to claim 1,
wherein
the predetermined position is a position typical of the applied state of the parking brake.

5. The method according to claim 1,
wherein
the predetermined position was determined as part of the determination of the first position during an earlier application operation.

6. The method according to claim 1,
wherein
the first position is compared with positions from a predetermined range.

7. An electronic parking brake that can be applied as part of a force control,
comprising:
means for determining a force during the application of the parking brake and, depending on the measured force, for determining at least one first position and therefore at least one force position assignment, and
a comparator for comparing the first position with a predetermined position for the purposes of a plausibility check of the force-position assignment.

8. The electronic parking brake according to claim 7, wherein
a force is present at the first position that corresponds to the applied state of the parking brake

9. The electronic parking brake according to claim 7, wherein
by determining several force-position assignments when the parking brake is being applied, at least one part of a force-position curve can be recorded.

10. The electronic parking brake according to claim 7, wherein
the predetermined position is a position typical of an applied status of the parking brake.

11. The electronic parking brake
the predetermined position can be determined as part of the determination of the first position during an earlier application operation.

12. The electronic parking brake according to claim 7, wherein
the first position is compared with positions from a predetermined range.

13. An operating brake with a device according to claim 7.

14. A motor vehicle with an electronic parking brake according to claim 7.

15. An electronic parking brake comprising:
a control unit,
a braking device coupled with a force transfer device;
a force sensor for determining a force during the activation of the braking device wherein depending on the measured force, at least one first position and therefore at least one force position assignment is determined by the control unit, and
wherein the control unit is operable to compare the first position with a predetermined position for the purposes of a plausibility check of the force-position assignment.

16. The electronic parking brake according to claim 15, wherein
a force is present at the first position that corresponds to the applied state of the parking brake

17. The electronic parking brake according to claim 15, wherein
by determining several force-position assignments when the parking brake is being applied, at least one part of a force-position curve can be recorded.

18. The electronic parking brake according to claim 15, wherein
the predetermined position is a position typical of an applied status of the parking brake.

19. The electronic parking brake according to claim 15, wherein
the predetermined position can be determined as part of the determination of the first position during an earlier application operation.

20. The electronic parking brake according to claim 15, wherein
the first position is compared with positions from a predetermined range.
